(19) United States
(12) Patent Application Publication
(10) Pub. No.: US 2026/0099730 A1
(43) Pub. Date: Apr. 9, 2026

(54) KNOWLEDGE BASE ARTICLE GENERATION SYSTEM AND METHOD USING INTEGRATED PROGRAMMATIC AND SPECIALIZED GUIDED AND CONSTRAINED ARTIFICIAL INTELLIGENCE

(71) Applicant: Trilogy Enterprises, Inc., Austin, TX (US)

(72) Inventors: Arthur Michel, Brooklyn, NY (US); Colin Guilfoyle, Drogheda (IE)

(73) Assignee: Trilogy Enterprises, Inc., Austin, TX (US)

(21) Appl. No.: 19/352,384

(22) Filed: Oct. 7, 2025

Related U.S. Application Data
(60) Provisional application No. 63/704,541, filed on Oct. 7, 2024.

(51) Int. Cl. G06N 5/022

(52) U.S. Cl. CPC G06N 5/022

(57) ABSTRACT

An automatic knowledge base article generation system and process receives a support ticket through a user interface integrated to a support platform, automatically processing the support ticket containing problem statements and their corresponding solutions. The automatic knowledge base article generation system and process employs an AI engine guided by generated prompts that transform unstructured the support ticket data into knowledge base articles. The AI engine extracts relevant problem statements and solutions from the support ticket using natural language processing (“NLP”) techniques and generates a knowledge base article. The knowledge base article is then transmitted to a knowledge base system for review.

### CROSS-REFERENCE TO RELATED APPLICATION(S)

This application claims the benefit under 35 U.S.C. § 119(e) and 37 C.F.R. § 1.78 of U.S. Provisional Application No. 63/704,541, which is incorporated by reference in its entirety.

### FIELD OF THE INVENTION

The present invention relates in general to the field of electronics and more specifically to automatic knowledge base article generation system and process for automatically generating knowledge base article from support ticket.

### DESCRIPTION OF THE RELATED ART

The evolution of support platforms traces back to when businesses first introduced dedicated help desks to address customer problems through phone and mail systems. As technology advanced, organizations transitioned from basic ticket logging to sophisticated knowledge management systems, recognizing the critical need to capture and reuse support solutions effectively. The traditional approach of manually creating a knowledge base article proved increasingly inadequate as support volumes grew exponentially with the digital revolution. Organizations attempted to enhance efficiency through a semi-automated systems and collaborative tagging mechanisms, yet these solutions only partially addressed the fundamental challenges of knowledge documentation. The persistent reliance on human intervention across all these approaches limited the reliability and expansion.

A support agent has traditionally relied on the support agent for manually creating the knowledge base article by analyzing customer interactions and documenting solutions. The manual approach to creating the knowledge base is labor-intensive and demands significant time and expertise from skilled support personnel, who must interpret complex problems, distill information, and format the information into the knowledge base article. The manual approach to creating the knowledge base introduces several critical challenges: a) the knowledge base article quality and structure vary widely between the different support agents due to inconsistent writing styles and documentation practices, b) requires a substantial operational burden that diverts the support agent from direct support, and organizations struggle to scale database alongside the growing support ticket volume without hiring additional staff, c) delays in publishing time-sensitive information, potential knowledge gaps when the experienced support agent leaves, and difficulties in maintaining consistent terminology and formatting across the database.

Building upon the manual approach of creating database, a semi-automated system is used to streamline the creation of the database. The semi-automated system provides humans with templates, content suggestions, and automation tools to assist in the database development. While the semi-automated system marks an improvement over the manual approach of creating the database, the semi-automated system demands substantial human intervention to review suggestions, fill in templates, and finalize content. The semi-automated system also introduces new challenges, such as the human struggle to balance template requirements with the need for customized content; automated suggestions may miss context-specific nuances, and the rigid structure of templates can limit the natural flow of information.

A collaborative tagging system to identify and prioritize common customer problems for the database creation where the support agent actively tags recurring problems as they encounter them in the ticketing system, building a collective database of potential documentation needs. The collaborative tagging system approach helps to detect emerging patterns and frequently occurring problems that warrant formal documentation. The multiple support agent contributes their insights by flagging and categorizing the support ticket, creating a dynamic trend-spotting mechanism within their daily workflow. However, the collaborative tagging systems still place a substantial burden on the support agent, who must manually draft, review, and finalize the database article once problems are identified.

### BRIEF DESCRIPTION OF THE DRAWINGS

The systems and methods described herein may be better understood, and their numerous objects, features, and advantages made apparent to those skilled in the art by referencing exemplary embodiments depicted in the accompanying figures. The use of the same reference number throughout the several figures designates a like or similar element.

FIG. 1 depicts an exemplary automatic knowledge base article generation system.

FIG. 2 depicts an exemplary automatic knowledge base article generation process utilized by the automatic knowledge base article generation system.

FIG. 3 depicts a sequence diagram for the automatic knowledge base article generation process through a widget, which is an embodiment of the automatic knowledge base article generation process of FIG. 2.

FIG. 4 depicts a data structure for automatic knowledge base article generation.

FIG. 5 depicts a user interface for the automatic knowledge base article generation process of FIG. 2.

FIG. 6 depicts a user interface for selection of a section, which is an embodiment of the automatic knowledge base article generation process of FIG. 2.

FIG. 7 depicts a user interface for control of visibility of knowledge base articles, which is an embodiment of the automatic knowledge base article generation process of FIG. 2.

FIG. 8 depicts a user interface having the choice to publish knowledge base articles, which is an embodiment of the automatic knowledge base article generation process of FIG. 2.

FIG. 9 depicts a flow chart representing the structure of a central support system.

FIG. 10 depicts an exemplary network environment in which the system of FIG. 1 and the process of FIG. 2 may be practiced.

FIG. 11 depicts an exemplary computer system.

### DETAILED DESCRIPTION

An automatic knowledge base article generation system and process receives a support ticket through a user interface integrated to a support platform, automatically processing the support ticket containing one or more problem statements and their corresponding solutions. The automatic knowledge base article generation system and process employs an AI engine guided by prompts that transform the support ticket into a knowledge base article. The AI engine extracts the problem statements and solutions from the support ticket using natural language processing (NLP) techniques and generates the knowledge base article. The knowledge base article is then transmitted to a knowledge base system for review.

The automatic knowledge base article generation system and process offers significant advantages over traditional knowledge base creation methods by providing full automation of the article generation process, eliminating the time-consuming manual effort previously required. Unlike earlier semi-automated systems that only offer basic templates or keyword extraction, the automatic knowledge base article generation system and process uses the AI engine to comprehensively analyze support tickets, understanding context and relationships between problems and solutions.

The automatic knowledge base article generation system and process uses the prompt generator and the AI engine to deliver the quality knowledge base article, addressing the inconsistency problems common in manually creating the knowledge base article approach or via the semi-automated system approach. The automatic knowledge base article generation system and process automatically organizes information into well-formatted articles with appropriate sections for problems, solutions, and related content.

The automated extraction of relevant information ensures that no critical details are missed, surpassing earlier systems that relied on agents' memory or note-taking abilities. Additionally, the system's ability to transmit articles directly to the knowledge base system for review streamlines the publication process, significantly reducing the time between solution discovery and documentation availability, a major improvement over traditional methods that often resulted in documentation backlogs.

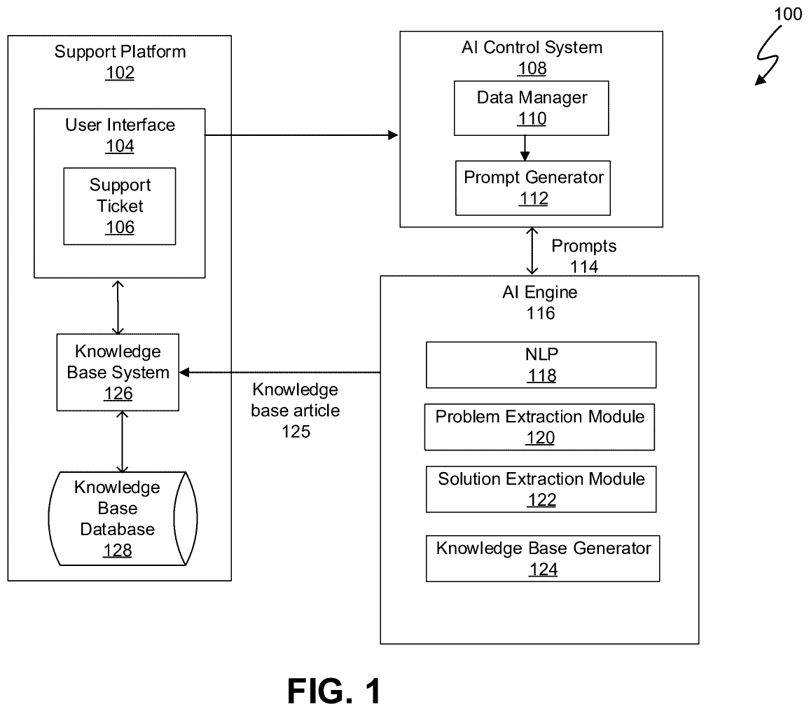

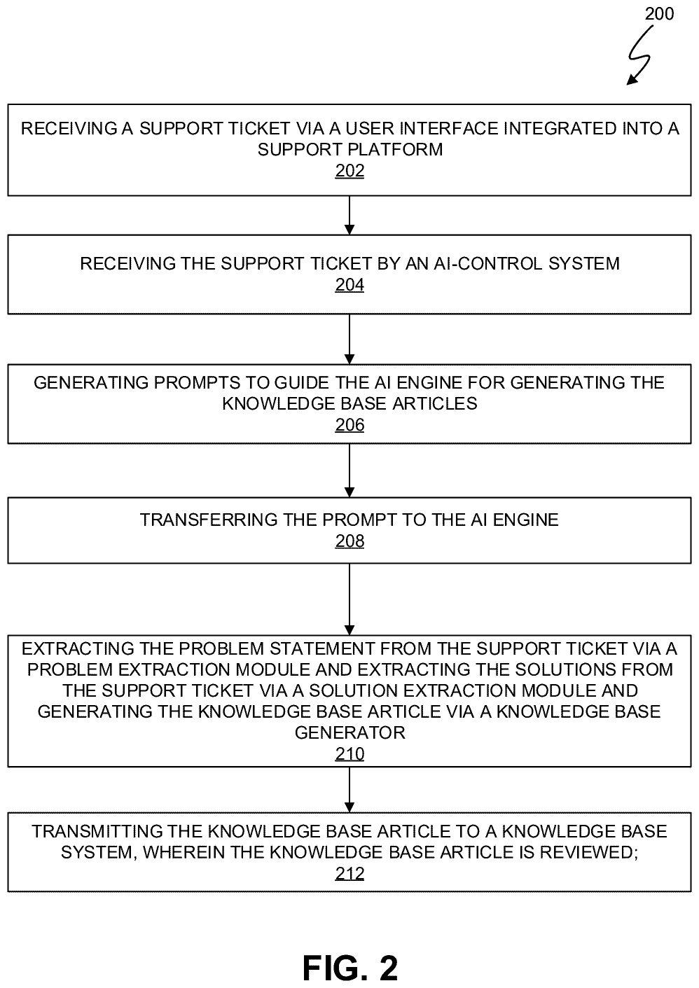

FIG. 1 depicts an exemplary automatic knowledge base article generation system 100. FIG. 2 depicts an exemplary automatic knowledge base article generation process 200 utilized by the automatic knowledge base article generation system 100.

Referring to FIGS. 1 and 2, in operation 202, receiving a support ticket 106 via a user interface 104 integrated into a support platform 102. The support ticket 106 includes one or more problem statements and corresponding solutions.

The support ticket 106 is a digital record that documents interactions between a customer and a support agent regarding the problem statement and corresponding solutions. In at least one embodiment, the support ticket 106 captures the complete lifecycle of a customer's support request, beginning with a description of the problem and continuing through to the final resolution. In at least one embodiment, the support ticket 106 contains structured data, including ticket identification numbers, customer information, timestamps, priority levels, and the complete thread of communications between all involved parties.

In at least one embodiment, the support ticket 106 maintains a chronological history of the problem-solving process, documenting the customer's initial report, troubleshooting steps taken, error messages encountered, and solutions implemented. Moreover, the support ticket 106 also includes metadata such as status updates, assignment information, and internal notes that help support teams manage and prioritize work effectively. The support ticket 106 includes attachments such as screenshots, log files, or configuration details, thereby providing additional context to the reported problem.

The support ticket 106 is either given manually to the user interface 104 or, in at least one embodiment, a Zendesk platform enables direct access to the support ticket 106 through a Zendesk application programming interface (“API”). An API is a set of protocols and routines that specifies how components interact with each other. The API defines the communication mechanisms between different components, allowing components to exchange data and perform actions seamlessly by providing a standardized way.

Below is an example for the support ticket 106:

In the above-mentioned example of the support ticket 106, the problem mentioned is that the staging environment of the customer became unusable after deployment, experiencing intermittent 500/404 errors across all application pages. The customer initially attempted to resolve the problem by applying Ruby version changes and restarting unicorn workers but encountered issues due to a version mismatch (Ruby 2.5.9 vs. 2.4.10) and stale worker problems.

The support agent escalated the support ticket 106 through multiple levels, ultimately providing a solution that involves a zero-downtime deployment strategy. While a cold restart of Unicorn resolved the immediate problem, the customer requested a method to upgrade Ruby versions without service interruption. The support agent delivered a detailed, step-by-step process using the platform's load balancer features, Chef configurations, and deployment tuning functionality to achieve a zero-downtime Ruby version upgrade.

The user interface 104 represents the point of interaction between customer and computer systems, providing a visual and functional framework through which the support agent interacts with the automatic knowledge base article generation process 200. The user interface 104 is integrated into the support platform 102.

The support platform 102 serves as a comprehensive digital ecosystem, integrating the user interface 104, the support ticket 106, a knowledge base system 126, and a knowledge base database 128. In at least one embodiment, the Zendesk platform is used as the support platform 102. The Zendesk platform provides cloud-based help desk solutions for the support ticket 106. The Zendesk platform is owned by Hellman & Friedman and Permira having headquarters in San Francisco, California. In another embodiment, Freshdesk, HappyFox, Help Scout, Intercom, Zoho Desk, LiveAgent, Front, HubSpot Service Hub, Kayako, and ServiceNow are utilized to provide cloud-based help desk solutions for the support ticket 106.

In operation 204, an AI-control system 108 receives the support ticket 106. The AI-control system 108 includes a data manager 110 and a prompt generator 112. The data manager 110 collects the required data for the prompt generator 112 to generate a plurality of prompts 114. The data manager 110, integrated within the AI-control system 108, collects and organizes the support ticket 106 to enable the generation of the plurality of prompts 114. When the support agent triggers, the knowledge base article 125 creation and the data manager 110 first retrieve the support ticket 106 content through the Zendesk API, including all customer messages, the support agent responses, and any internal notes if specified.

The data manager 110 then processes the support ticket 106 by extracting relevant fields, organizing the conversation flow, and identifying key message timestamps and sequences. The data manager 110 actively filters and structures the support ticket 106 into a format optimized for the prompt generator 112 to use.

For the support ticket 106 with uploaded transcripts, the data manager 110 also incorporates this additional content as supplementary insights. The data manager 110 maintains direct integration with both the support platform 102 and the prompt generator 112, ensuring seamless data flow between them.

In at least one embodiment, the data manager 110 utilizes a data parsing process to convert the support ticket 106 into a format suitable for processing by a natural language processor (NLP) 118. The data parsing transforms raw information of the support ticket 106 into a structured format that the AI engine 116 can effectively analyze and process. The data parsing actively breaks down the support ticket 106 content into distinct components, separating customer problems from the support agent responses and identifying critical elements like error messages, steps taken, and solutions provided.

The data parsing extracts key metadata such as timestamps, ticket IDs, and user information while organizing the conversational flow into a clear sequence. The data parsing process removes any unnecessary formatting, standardizes text representations, and creates a clean data structure that highlights the relationships between the problem statement and the corresponding solutions. The structured format allows the NLP 118 to accurately identify patterns, understand context, and extract relevant information for the generation of knowledge base article 125. The data parsing ensures that all vital ticket information, along with its logical connections and semantic meaning, is presented in a format optimized for the NLP 118 analysis.

The prompt generator 112 generates plurality of prompts 114 to guide an AI engine 116 to generate the knowledge base article 125. When the prompt generator 112 receives structured data from the data manager 110, the prompt generator 112 analyzes the information and constructs the plurality of prompts 114. The prompt generator 112 generates the plurality of the prompts 114 based on the skeleton created by a prompt engineer. The plurality of prompts 114 includes a first prompt, second prompt, and third prompt.

The prompt generator 112 generates the first prompt to instruct the AI engine 116 to identify the problem statement(s) from the support ticket 106 while filtering out irrelevant information. The prompt generator 112 generates the second prompt for directing the AI engine 116 to extract the solution from the support ticket 106, specifically distinguishing between working solutions and unsuccessful troubleshooting attempts. The prompt generator 112 generates the third prompt that guides the AI engine 116 in formatting the extracted information into the knowledge base article 125.

The prompt generator 112 incorporates quality control requirements into each prompt, ensuring the AI engine 116 receives clear, consistent instructions for generating the knowledge base article 125. Throughout the automatic knowledge base article generation process 200, the prompt generator 112 maintains active communication with both the data manager 110 and the AI engine 116, orchestrating the transformation of the support ticket 106 into the knowledge base article 125.

In operation 206, the prompt generator 112 generates the plurality of prompts 114 to guide the AI engine 116 for generating the knowledge base article 125. The plurality of prompts 114 include one or more inputs received from the support ticket 106. When the prompt generator 112 receives structured data from the data manager 110, the prompt generator 112 analyzes this information and constructs a series of three distinct prompts.

The prompt generator 112 executes the plurality of prompts 114, including: The first prompt to identify and extract the problem statement.

The above-mentioned prompt actively instructs the AI engine 116 to function as a technical support expert with deep knowledge of help center content and customer problems. The first prompt directs the AI engine 116 to analyze the resolved the support ticket 106 which contains both the customer messages and the support agent responses, focusing on identifying and summarizing the problem statement(s) in a concise one to two-paragraph description. Through four specific notes, the first prompt guides the AI engine 116 to abstract customer-specific details, filter irrelevant information, separate symptoms from root causes, and preserve critical error messages. The first prompt emphasizes creating a generalized, reusable problem description that will help other users identify similar problems in the knowledge base. The prompt concludes with explicit formatting requirements, demanding only a focused summary stripped of unnecessary details. The prompt structured guidance ensures the AI engine 116 produces standardized, useful the problem statement identifications that serve as the foundation for the knowledge base article 125.

The second prompt is configured to guide the AI engine 116 to identify and extract the solution that resolved the problem statement.

The above-mentioned second prompt actively guides the AI engine 116 to function as a technical support expert tasked with identifying and extracting solution information from resolved the support ticket. The second prompt directs the AI engine 116 to analyze both customer messages and the support agent responses while focusing specifically on the successful solution steps. The second prompt instructs the AI engine 116 to abstract away customer-specific details and filter out irrelevant information or unsuccessful troubleshooting attempts. The second prompt tells the AI engine 116 to recognize that the support agent may provide incorrect solutions initially and to identify the final working solution, typically found in later interactions. The second prompt emphasizes that the AI engine 116 will receive an expert's problem description first and must ensure its solution directly addresses that defined the problem statement. Through specific formatting instructions, the second prompt requires the AI engine 116 to present only the essential solution steps without repeating the problem statement or adding unnecessary headers. The second prompt helps the AI engine 116 produce clear, solution content that other customers can follow when encountering similar problems.

The third prompt is configured to guide the AI engine 116 to generate the knowledge base article 125.

The above-mentioned third prompt asks the AI engine 116 to write the knowledge base article 125 in a specific JSON format. When given the problem statement(s) and solution(s), the AI engine 116 needs to craft the knowledge base article 125 that includes a clear title, problem overview, solution steps, summary, FAQs section, and relevant tags.

The knowledge base article 125 follows strict quality control guidelines. The guidelines include using precise titles that start with “How to” or “Troubleshooting,” providing clearly structured problem definitions, breaking down solutions into numbered steps, using proper HTML markup, writing in plain language, maintaining consistent formatting, and including appropriate metadata tags. The AI engine 116 writes 3-questions in the FAQ section to help readers better navigate the content.

The final output must be formatted as a JSON object with specific fields including the article title, HTML body content, and predefined technical values for user segments, permissions, and locale settings. The HTML body should use h1 tags for main section headers and h2 tags for FAQs.

In operation 208 the prompt generator 112 transfers the plurality of prompts 114 to the AI engine 116. The prompt generator 112 creates and transfers plurality of prompts 114 in sequence to the AI engine 116. The first prompt instructs the AI engine 116 identify and extract the problem statement from the support ticket 106. Once the AI engine 116 process this and returns the problem identification, the second prompt is sent directing the AI engine 116 to identify the solution from the support ticket 106 content. After receiving both the problem and solution components, the third prompt is transferred instructing the AI engine 116 to generate the knowledge base article 125 in JSON format with proper formatting, structure, and metadata.

In at least one embodiment, the AI engine 116 undergoes comprehensive training using an extensive dataset of historical support ticket(s) 106 to develop text processing capabilities. Through supervised learning, the AI engine 116 learns from labeled examples that demonstrate the correct identification of the problem statement, extraction of solutions, and generation of the knowledge base article 125.

The supervised learning enables the AI engine 116 to understand the context and structure of the communication of the support ticket 106, allowing the AI engine 116 to accurately process new support tickets 106 and generate the knowledge base article 125 in an efficient way. The training data includes various scenarios and examples, helping the AI engine 116 recognize different types of support ticket 106, the problem statement, and their corresponding solutions.

The supervised learning approach ensures the AI engine 116 maintains consistent quality and accuracy in its outputs, following established patterns from the labeled training examples to properly structure and format the knowledge base article 125.

The AI engine 116 employs the NLP techniques through the NLP 118 to comprehensively analyze the support ticket 106. Using a problem extraction module 120 and a solution extraction module 122, the NLP 118 processes unstructured text from the support ticket 106 to intelligently identify and extract the problem statement and corresponding solutions. The NLP 118 enable the AI engine 116 to understand the context, semantics, and structure of support communications, distinguishing between customer, the support agent, and solution. Through a knowledge base generator 124, the AI engine 116 applies the NLP 118 to transform the extracted components into the knowledge base article 125, complete with appropriate formatting, FAQs, and content labels. The NLP 118 ensures accurate interpretation of the support ticket 106 and consistent generation of the knowledge base article 125.

In at least one embodiment, the function used by the NLP 118 is as follows:

function generateKBArticle(ticketData):
parsedData = parseData(ticketData)
problem, solution = identifyProblemSolution(parsedData)
article = formatArticle(problem, solution)
publishArticle(article)
return article

A generateKBArticle function creates the knowledge base article 125 by processing the support ticket 106 through four main steps. First, the generateKBArticle function parses the support ticket 106 into a structured format using a parseData function. Then, the generateKBArticle function analyzes this parsed information to identify and separate the problem statement and solution using identifyProblemSolution function. Next, the generateKBArticle function takes these components and formats them into the knowledge base article 125 using a formatArticle function, which likely adds appropriate headers, sections, and formatting. Finally, the generateKBArticle function publishes the formatted article to the knowledge base system 126 through a publishArticle and returns the knowledge base article 125.

In operation 210, the problem extraction module 120 extracts the problem statement from the support ticket 106, the solution extraction module 122 extracts the solutions from the support ticket 106, and the knowledge base generator 124 generates the knowledge base article 125.

The AI engine 116 using the NLP 118 extracts the problem statement from the support ticket 106 through the problem extraction module 120. When the support ticket 106 is submitted for processing, the problem extraction module 120 analyzes the support ticket 106, particularly focusing on the initial messages and customer descriptions. The problem extraction module 120 identifies the problem by examining the first few messages of the ticket, where problem statements are typically described.

In the case of longer support ticket 106, the AI engine 116 specifically concentrates on the opening portions of the support ticket 106 to accurately capture the problem statement. The extraction process filters out information like internal notes and agent communications that don't directly relate to the problem statement. The problem extraction module 120 processes the problem statement through the AI engine 116 using the first prompt designed to identify and extract the problem statement. The extracted problem statement then serves as a foundational element for the automatic knowledge base article generation process 200.

Example of the output for the problem extraction module 120 is:

In the above example, the customer is experiencing 500/404 errors and stale unicorn worker problems in their staging environment due to Ruby version conflicts between their Gemfile (2.4.10) and server (2.5.9). While server checks show Ruby 2.4.10 is installed, the application reports version mismatches during deployment. The problem is that Ruby version changes require a cold restart of Unicorn, causing service disruptions. The customer seeks a zero-downtime deployment solution, proposing to detach current app instances before deployment and add new ones after the Ruby upgrade

The AI engine 116 extracts solutions from the support ticket 106 through the solution extraction module 122, which is integrated into the AI engine 116. When processing the support ticket 106, the solution extraction module 122 specifically analyzes the support agent responses and final solutions, focusing particularly on messages that successfully resolved the customer's problem.

The solution extraction module 122 examines the latter portions of the communication in the support ticket 106, where solutions are typically documented, and intelligently filters through the back-and-forth communications to identify the actual solution steps that resolved the problem statement.

In at least one embodiment for longer tickets, the AI engine 116 concentrates on the final messages and combines these with the problem description to ensure context is maintained. The solution extraction module 122 distinguishes between unsuccessful troubleshooting attempts and the final working solution, ensuring only the effective solution steps are captured. The AI engine 116 uses the second prompt designed to identify and extract the solution.

Example of the output for the solution extraction module 122 is:

In the above example, the solution is provided to the customer stating a cold restart is required when changing Ruby versions in Unicorn, as workers need to use the new Ruby version, and normal deployment only attempts a cold restart. The solution involves a two-phase approach: first, disable app master takeover, prepare Chef recipes, and change Ruby version settings without applying them. Then, for each app instance individually, hide other instances, stop Nginx and Unicorn, apply the new Ruby version, deploy the application, and test Unicorn functionality. Finally, restart Nginx on each instance once testing confirms proper operation, enabling zero-downtime deployment by rolling through instances one at a time.

The AI engine 116 actively generates the knowledge base article 125 through the knowledge base generator 124 component within the AI engine 116. Upon receiving the extracted problem statement and solution, the knowledge base generator 124 creates the knowledge base article 125 in multiple steps.

The knowledge base generator 124 organizes the content into a standardized format, including a clear title, problem overview, step-by-step solution guidance, and relevant FAQs. The knowledge base generator 124 then formats this content into HTML structure and creates JSON output that includes all necessary metadata for Zendesk platform.

In at least one embodiment, the knowledge base generator 124 generates content labels to aid in article categorization and searchability, while also creating supplementary FAQs based on common related questions derived from the solution context. Working through a write_kb lambda function, the write_kb lambda function produces the knowledge base article 125 that maintain consistent formatting and quality standards, incorporating proper headers, lists, and technical details where appropriate.

Example of the input and output for the knowledge base generator 124 is

In the above example, the problem statement and corresponding solution are given, and the knowledge base generator 124 has generated the knowledge base article 125 for the problem statement and corresponding solution.

In operation 212, the knowledge base system 126 receives the knowledge base article 125. The knowledge base system 126 is configured to review the knowledge base article 125. The AI engine 116 transmits the knowledge base article 125 to the knowledge base system 126, which is integrated into the support platform 102. After the AI engine 116 generates the knowledge base article 125, the AI engine 116 packages the knowledge base article 125 into a JSON file containing the article title, formatted HTML body content, FAQs, and appropriate metadata. The lambda function transmits the package of the knowledge base article 125 to the knowledge base system 126 integrated to the support platform 102 using the API. For example, a write_kb lambda function transmits the knowledge base article 125 to Zendesk platform using the Zendesk API, authenticating the request with the user's email and Zendesk API token.

The knowledge base system 126 performs a review of the knowledge base article 125 through either human review or automated validation. After the knowledge base article 125 is received, the knowledge base article 125 follows one of two paths-either the system submits the knowledge base system 126 for manual reviewing where the knowledge base article 125 is examined, or the knowledge base article 125 applies automated troubleshooting codes to validate the knowledge base article 125 accuracy and completeness. After passing the chosen review method, the knowledge base system 126 stores the approved article in the knowledge base database 128. In at least one embodiment, a ZD_TOKEN authenticates and configures environment variables, ensuring the integrity of the knowledge base content while the knowledge base article 125 creation and storage workflow.

In at least one embodiment, the knowledge base database 128 maintains proper data organization through the configured environment variables, including:
ZD_SEGMENT_ID (set to “Agents and admins” by default, 360000084973)
ZD_PERMISSION_ID (set to “Agents and admins” by default, 1075294)

In at least one embodiment, the AI engine 116 generates descriptive content labels by analyzing both the problem statement and the solution extracted from the support ticket 106. The knowledge base generator 124, integrated into the AI engine 116, creates relevant labels that capture the key topics and technical aspects of the knowledge base article 125. The generated labels are then used for automated categorization. The knowledge base system 126 compares the labels against existing knowledge base database 128 sections. When a matching section is found based on the content labels, the knowledge base system 126 automatically files the knowledge base article 125. If no clear match exists, the knowledge base system 126 places the article in a default section.

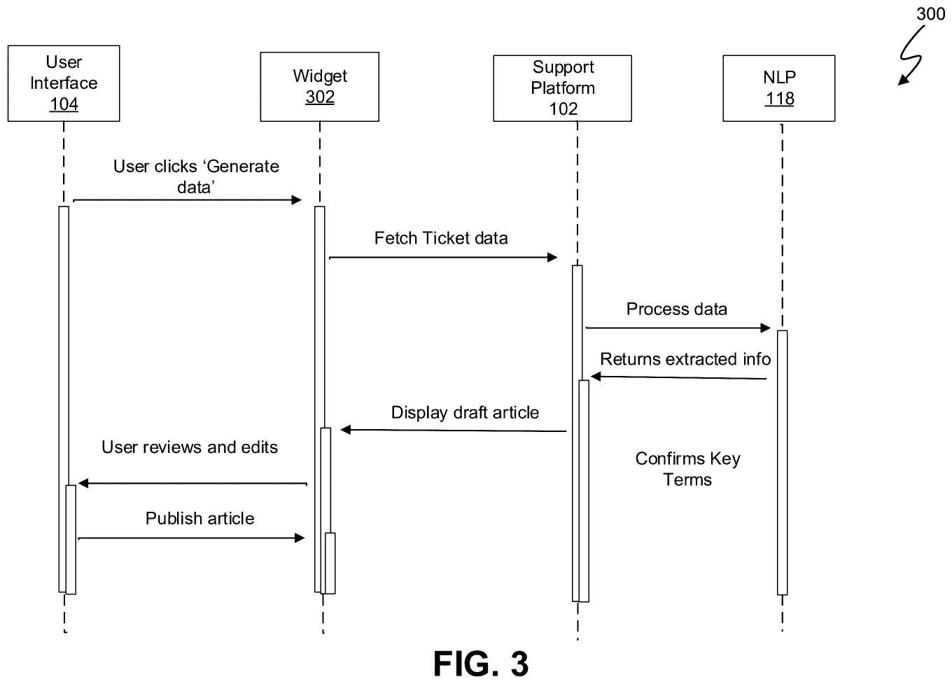

FIG. 3 depicts a sequence diagram 300 for the automatic knowledge base article generation process through a widget 302, which is an embodiment of the automatic knowledge base article generation process 200 of FIG. 2. The sequence begins when the support agent clicks the “Generate data” button on the user interface 104, sending a request to the widget 302. The widget 302 then reaches out to the support platform 102 to fetch the relevant support ticket 106.

The support platform 102 takes the support ticket 106 and forwards it to the NLP 118 for processing. After analyzing the support ticket 106, the NLP 118 extracts the key information, and the generate knowledge base article 125 returns the generate the knowledge base article 125 back to the support platform 102. The support platform 102 formats the knowledge base article 125 information by making the knowledge base article 125 in a template format and sends the knowledge base article 125 to the widget 302 for display. The widget 302 presents the generated the knowledge base article 125 to the user interface 104, where the support agent reviews and makes any necessary edits. Finally, the user interface 104 sends the support agents command to publish the reviewed the knowledge base article 125 back to the widget 302, which handles the final publication.

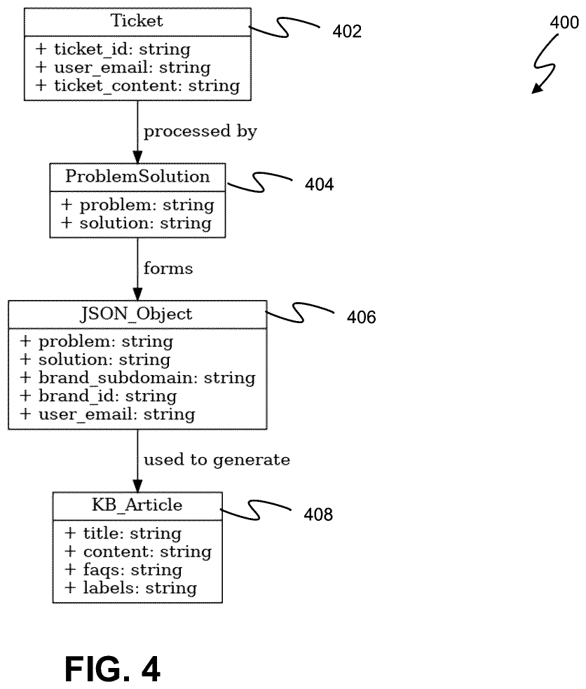

FIG. 4 depicts a data structure 400 configured to store data for automatic knowledge base article generation. The data structure is composed of distinct modules, each dedicated to store specific types of information. These modules includes a ticket 402 module, a problemsolution 404 module, a JSON_Object 406 module, and a KB_Article 408.

The ticket 402 module captures details related to the support ticket 106 including fields for ticket ID in string data type, user email in string data type, and ticket content in string data type. Here, string is a sequence of characters (letters) treated as a single unit of data type

The ProblemSolution 404 module stores details related to the extracted problem statement and the solution from the support ticket 106 in a string data type.

The JSON_Object 406 is an intermediate data structure. The JSON_Object 406 includes problem, solution, brand_subdomain, brand_id, user_email required for creating the knowledge base article 125, which are in string data type.

The KB_Article 408 represents the final knowledge base article 125. The KB_Article 408 title, content, FAQs, and labels, which are in string data type.

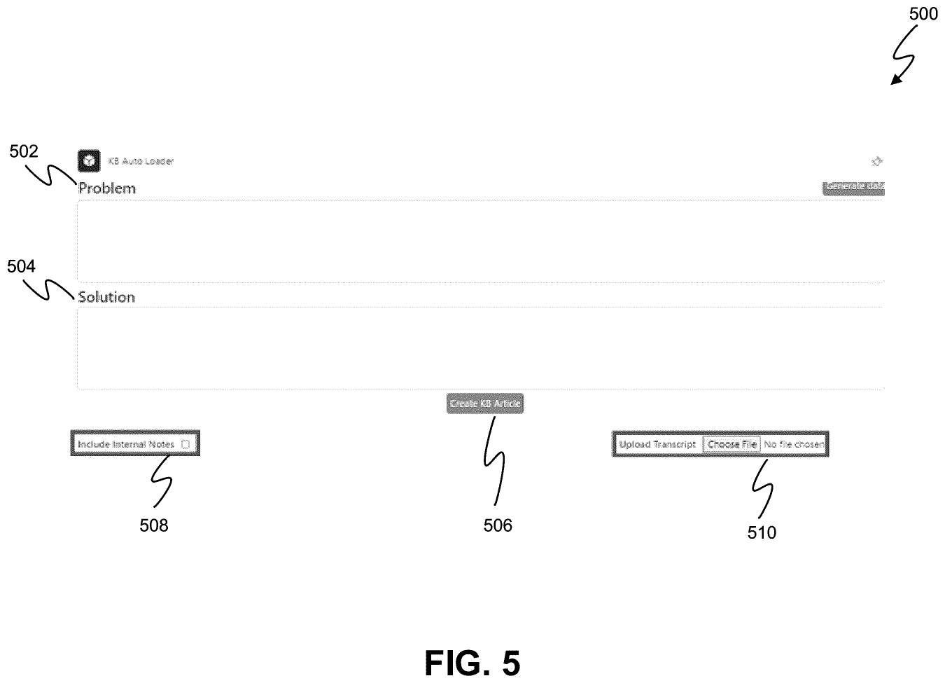

FIG. 5 depicts a user interface 500 for the automatic knowledge base article generation process 200 of FIG. 2. A problem box 502 where the support agent can enter the problem statement description. A solution box 504 where the support agent can enter the solution description. An action button 506 to “Create KB Article” triggers the automatic knowledge base article generation process 200. Additional options include an “Include Internal Notes” checkbox 508, which allows the support agent to include internal ticket notes in the automatic knowledge base article generation process 200. An upload Transcript button 510 having a choose file button enables the support agent to upload transcript files (in TXT format) that may contain additional context from voice chats or customer meetings.

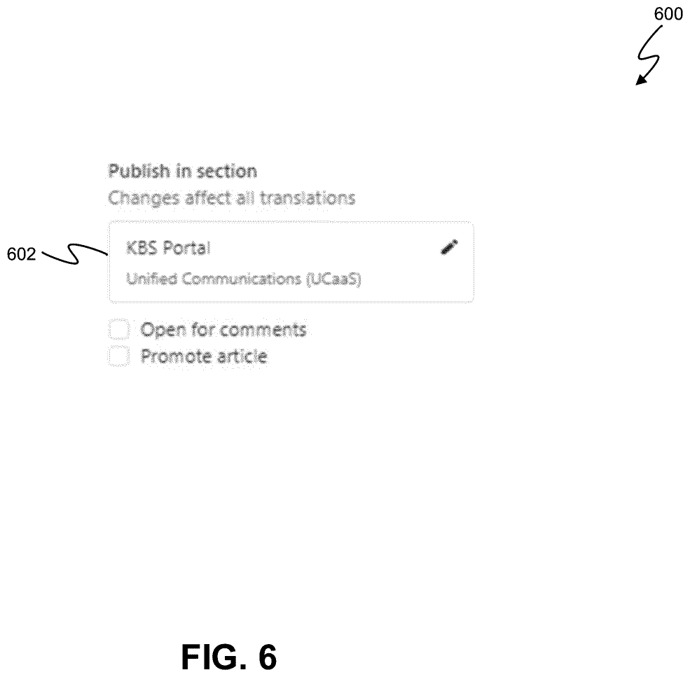

FIG. 6 depicts a user interface 600 for selection of a section, which is an embodiment of the automatic knowledge base article generation process 200 of FIG. 2. The automatic knowledge base article generation process 200 automatically selects a section related to the topic of the knowledge base article 125. The selection is made manually. The manual selection of the section can be done by clicking the 602 box.

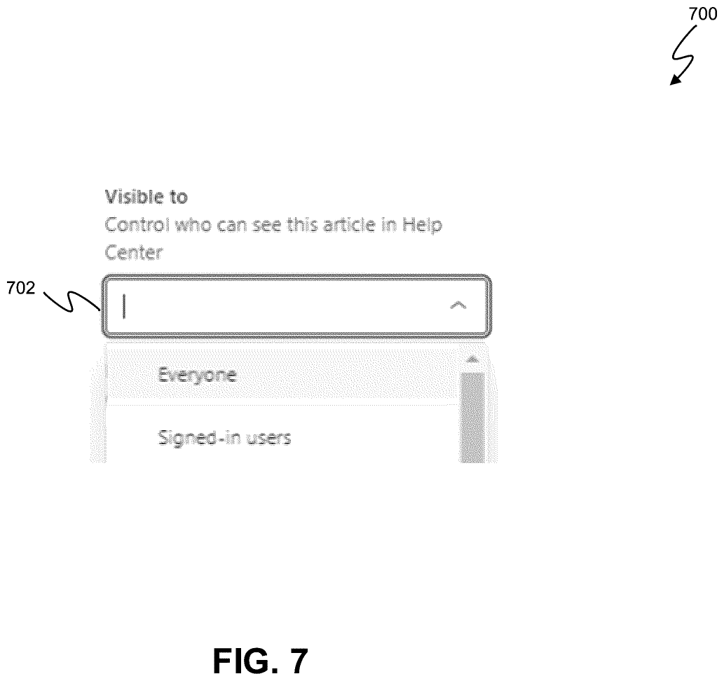

FIG. 7 depicts a user interface 700 for control of visibility of knowledge base articles, which is an embodiment of the automatic knowledge base article generation process 200 of FIG. 2. A selection box 702 allows the selection of who all can see the generated knowledge base article 125. For example, the visibility of the knowledge base article 125 can be limited to a sign in users only, or the visibility can be given to everyone.

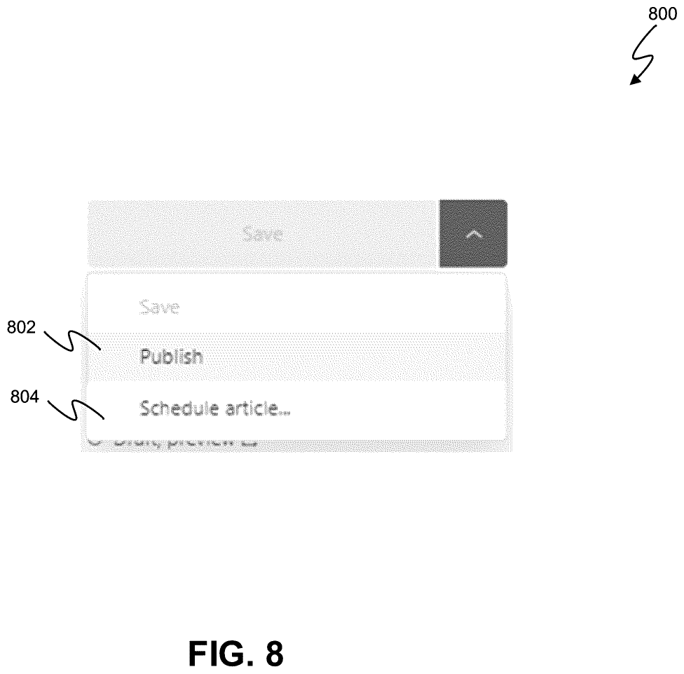

FIG. 8 depicts a user interface 800 having the choice to publish the knowledge base article, which is an embodiment of the automatic knowledge base article generation process 200 of FIG. 2. If the knowledge base article 125 needs to be published, the support agent can choose a publish 802 option, or if the support agent wants to schedule the publication of the knowledge base article 125, then the support agent can choose a schedule article 804 option.

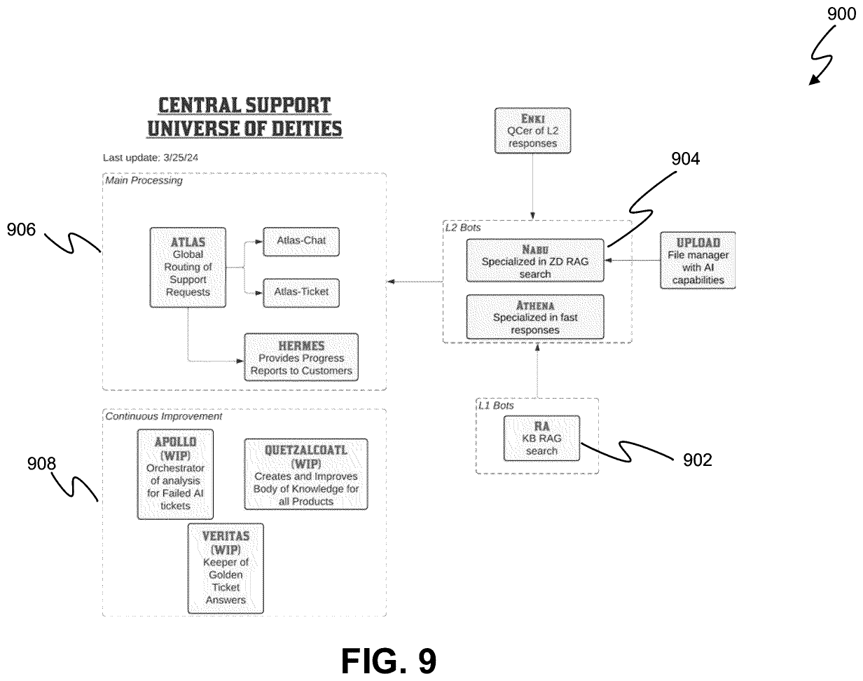

FIG. 9 depicts a flow chart representing the structure of a central support system 900. The flow chart outlines the interactions between L1 bots 902, L2 bots 904, main processing 906 unit that receive and route the customer tickets received through customer ticketing platform (e.g., Zendesk), and continuous improvement 908 module.

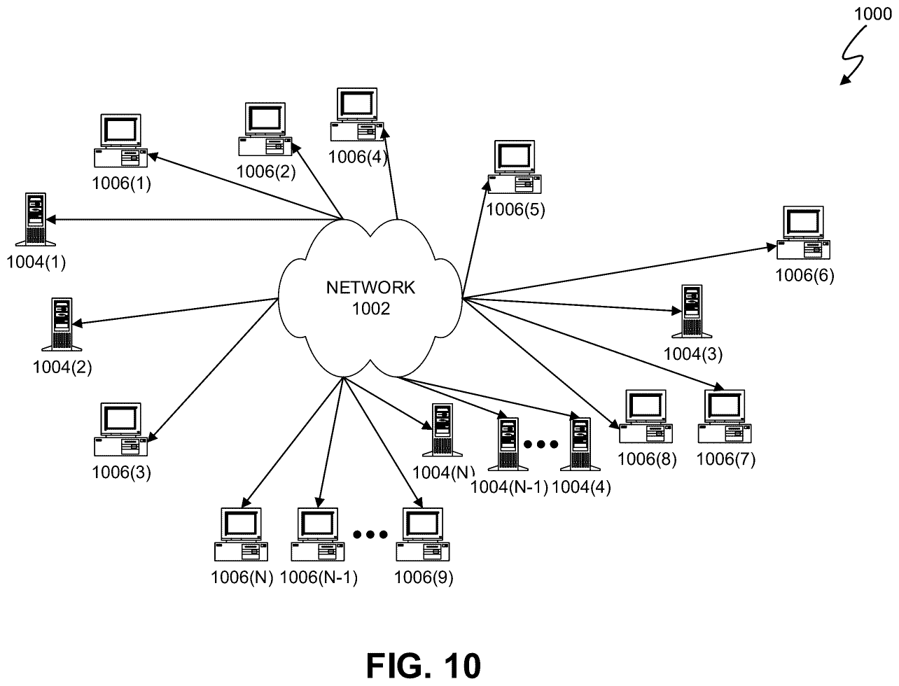

FIG. 10 is a block diagram illustrating a network environment in which an automatic knowledge base article generation system 100 and an automatic knowledge base article generation process 200 may be practiced. Network 1002 (e.g. a private wide area network (WAN) or the Internet) includes a number of networked server computer systems 1004(1)-(N) that are accessible by client computer systems 1006(1)-(N), where N is the number of server computer systems connected to the network. Communication between client computer systems 1006(1)-(N) and server computer systems 1004(1)-(N) typically occurs over a network, such as a public switched telephone network over asynchronous digital subscriber line (ADSL) telephone lines or high-bandwidth trunks, for example communications channels providing T1 or OC3 service. Client computer systems 1006(1)-(N) typically access server computer systems 1004(1)-(N) through a service provider, such as an internet service provider (“ISP”) by executing application specific software, commonly referred to as a browser, on one of client computer systems 1006(1)-(N).

Client computer systems 1006(1)-(N) and/or server computer systems 1004(1)-(N) are specialized computer programmed to improve conventional computer systems to implement and utilize the automatic knowledge base article generation system 100 and the automatic knowledge base article generation process 200. The type of computer system that can be specially programmed to implement and utilize the automatic knowledge base article generation system 100 and the automatic knowledge base article generation process 200 include a mainframe, a mini-computer, a personal computer system including notebook computers, a wireless, mobile computing device (including personal digital assistants, smart phones, and tablet computers). These computer systems are typically designed to provide computing power to one or more users, either locally or remotely. Each computer system may also include one or a plurality of input/output (“I/O”) devices coupled to the system processor to perform specialized functions. Tangible, non-transitory memories (also referred to as “storage devices”) such as hard disks, compact disk (“CD”) drives, digital versatile disk (“DVD”) drives, and magneto-optical drives may also be provided, either as an integrated or peripheral device. In at least one embodiment, the automatic knowledge base article generation system 100 and the automatic knowledge base article generation process 200 can be implemented using code stored in a tangible, non-transient computer readable medium and executed by one or more processors. In at least one embodiment, the automatic knowledge base article generation system 100 and the automatic knowledge base article generation process 200 can be implemented completely in hardware using, for example, logic circuits and other circuits including field programmable gate arrays.

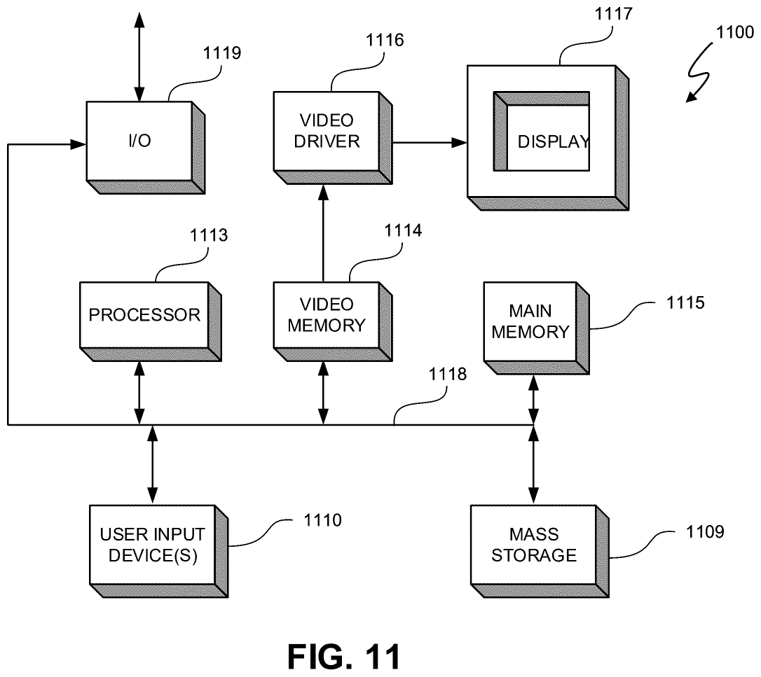

Embodiments of the automatic knowledge base article generation system 100 and the automatic knowledge base article generation process 200 can be implemented on a computer system such as a special-purpose, special-programmed computer 1100 illustrated in FIG. 11. Input user device(s) 1110, such as a keyboard and/or mouse, are coupled to a bi-directional system bus 1118. The input user device(s) 1110 are for introducing user input to the computer system and communicating that user input to processor 1113. The computer system of FIG. 11 generally also includes a non-transitory video memory 1114, non-transitory main memory 1115, and non-transitory mass storage 1109, all coupled to bi-directional system bus 1118 along with input user device(s) 1110 and processor 1113. The mass storage 1109 may include both fixed and removable media, such as a hard drive, one or more CDs or DVDs, solid state memory including flash memory, and other available mass storage technology. Bus 1118 may contain, for example, 32 of 64 address lines for addressing video memory 1114 or main memory 1115. The system bus 1118 also includes, for example, an n-bit data bus for transferring DATA between and among the components, such as CPU 1109, main memory 1115, video memory 1114 and mass storage 1109, where “n” is, for example, 32 or 64. Alternatively, multiplex data/address lines may be used instead of separate data and address lines.

I/O device(s) 1119 may provide connections to peripheral devices, such as a printer, and may also provide a direct connection to a remote server computer systems via a telephone link or to the Internet via an ISP. I/O device(s) 1119 may also include a network interface device to provide a direct connection to a remote server computer systems via a direct network link to the Internet via a POP (point of presence). Such connection may be made using, for example, wireless techniques, including digital cellular telephone connection, Cellular Digital Packet Data (CDPD) connection, digital satellite data connection or the like. Examples of I/O devices include modems, sound and video devices, and specialized communication devices such as the aforementioned network interface.

Computer programs and data are generally stored as code in a non-transient computer readable medium such as a flash memory, optical memory, magnetic memory, compact disks, digital versatile disks, and any other type of memory. The computer program is loaded from a memory, such as mass storage 1109, into main memory 1115 for execution. “Memory” can be a single memory component or a collection of multiple memory components. Computer programs may also be in the form of electronic signals modulated in accordance with the computer program and data communication technology when transferred via a network. In at least one embodiment, Java applets or any other technology is used with web pages to allow a user of a web browser to make and submit selections and allow a client computer system to capture the user selection and submit the selection data to a server computer system.

The processor 1113, in one embodiment, is a microprocessor manufactured by Motorola Inc. of Illinois, Intel Corporation of California, or Advanced Micro Devices of California. However, any other suitable single or multiple microprocessors or microcomputers may be utilized. Main memory 1115 is comprised of dynamic random access memory (DRAM). Video memory 1114 is a dual-ported video random access memory. One port of the video memory 1114 is coupled to video amplifier 1116. The video amplifier 1116 is used to drive the display 1117. Video amplifier 1116 is well known in the art and may be implemented by any suitable means. This circuitry converts pixel DATA stored in video memory 1114 to a raster signal suitable for use by display 1117. Display 1117 is a type of monitor suitable for displaying graphic images.

The computer system described above is for purposes of example only. The automatic knowledge base article generation system 100 and the automatic knowledge base article generation process 200 may be implemented in any type of computer system or programming or processing environment. It is contemplated that the automatic knowledge base article generation system 100 and the automatic knowledge base article generation process 200 might be run on a stand-alone computer system, such as the one described above. The automatic knowledge base article generation system 100 and the automatic knowledge base article generation process 200 might also be run from a server computer systems system that can be accessed by a plurality of client computer systems interconnected over an intranet network. Finally, the automatic knowledge base article generation system 100 and the automatic knowledge base article generation process 200 may be run from a server computer system that is accessible to clients over the Internet.

Although embodiments have been described in detail, it should be understood that various changes, substitutions, and alterations can be made hereto without departing from the spirit and scope of the invention as defined by the appended claims.

What is claimed is:

1. A method to guide an Artificial Intelligence (AI) engine to automatically generate a knowledge base article from at least one support ticket, comprising:
executing code using one or more processors of a computer system to cause the computer system to perform operations comprising:
receiving the at least one support ticket via a user interface integrated into a support platform, wherein the at least one support ticket includes one or more problem statements and corresponding solutions;
accessing the at least one support ticket by an AI-control system, wherein the AI-control system includes a data manager and a prompt generator;
generating a plurality of prompts by the prompt generator to guide the AI engine for generating the knowledge base article, wherein the plurality of prompts includes one or more inputs received from the at least one support ticket;
transferring the plurality of prompts to the AI engine, wherein the AI engine is configured to:
extracting the one or more problem statement and the solutions from the at least one support ticket; and
generating the knowledge base article; and
transmitting the generated knowledge base article to a knowledge base system, wherein the knowledge base system is configured to review the knowledge base article.

2. The method of claim 1, wherein generating the plurality of prompts include executing a chain of prompts comprising:
a first prompt to identify and extract the one or more problem statements,
a second prompt to identify and extract the solutions that resolved the one or more problem statements, and
a third prompt to generate the knowledge base article.

3. The method of claim 1 wherein the knowledge base article comprises: a title, the one or more problem statement, the step-by-step solution, and supplemental information addressing frequently asked questions about the solution.

4. The method of claim 1 further comprising generating content labels for the knowledge base article based on analysis of the one or more problem statements and solutions and selecting an appropriate category section in the knowledge base for the article by analyzing the content label.

5. The method of claim 1 further comprising receiving an uploaded transcript file containing additional at least one support ticket resolution details, analyzing the transcript content using the natural language processor to extract supplementary insights, and incorporating the extracted insights into the knowledge base article during generation.

6. The method of claim 1 wherein reviewing the knowledge base article comprises at least one of—submitting the knowledge base article to human review or applying automated troubleshooting codes to validate the knowledge base article.

7. The method of claim 1 wherein the AI engine utilizes natural language processing (NLP) for identifying and extracting the one or more problem statements, solutions and generating the knowledge base article.

8. The method of claim 1 wherein the AI engine is trained on a large dataset including the dataset related to the at least one support ticket, wherein the training involves supervised learning such that the model learns to identify, extract and generate text based on labeled examples.

9. The method of claim 1 wherein data parsing is used to convert at least one support ticket into a format suitable for processing by the NLP.

10. The method of claim 1 wherein the knowledge base article is stored in a knowledge base database.

11. The method of claim 1 wherein a data manager integrated into an AI-control system, collects the required data for a prompt generator to generate the plurality of prompts.

12. A system to guide an Artificial Intelligence (AI) engine to automatically generate a knowledge base article from at least one support ticket, comprising:
one or more processors of a computer system; and
a memory, coupled to the one or more processors, that stores code and execution of the code by the one or more processors causes the computer system to perform operations comprising:
executing codes using one or more processors of a computer system to cause the computer system to perform operations comprising:
receiving the at least one support ticket via a user interface integrated into a support platform, wherein the at least one support ticket includes one or more problem statement and corresponding solutions;
accessing the at least one support ticket by an AI-control system, wherein the AI-control system includes a data manager and a prompt generator;
generating a plurality of prompts by the prompt generator to guide the AI engine for generating the knowledge base article, wherein the plurality of prompts includes one or more inputs received from the at least one support ticket;
transferring the plurality of prompts to the AI engine, wherein the AI engine is configured to:
extracting the one or more problem statement from the at least one support ticket via a problem extraction module,
extracting the solutions from the at least one support ticket via a solution extraction module; and
generating the knowledge base article via a knowledge base generator; and
transmitting the generated knowledge base article to a knowledge base system, wherein the knowledge base system is configured to review the knowledge base article.

13. The system of claim 1 wherein generating the plurality of prompts comprises:
executing a chain of prompts comprising:
a first prompt to identify and extract the one or more problem statement, a second prompt to identify and extract the solution that resolved the one or more problem statement, and
a third prompt to generate the knowledge base article.

14. The system of claim 1 wherein the knowledge base article comprises a title, one or more problem statements, step-by-step solution, and supplemental information addressing frequently asked questions about the solution.

15. The system of claim 1 further comprising generating content labels for the knowledge base article based on analysis of the one or more problem statement and solutions and selecting an appropriate category section in the knowledge base for the article by analyzing the content label.

16. The system of claim 1 further comprising receiving an uploaded transcript file containing additional the at least one support ticket resolution details, analyzing the transcript content using the natural language processor to extract supplementary insights, and incorporating the extracted insights into the knowledge base article during generation.

17. The system of claim 1 wherein reviewing the knowledge base article comprises at least one of—: submitting the knowledge base article to human review or applying automated troubleshooting codes to validate the knowledge base article.

18. The system of claim 1 wherein the AI engine utilizes natural language processing (NLP) for identifying and extracting the one or more problem statements, solutions and generating the knowledge base article.

19. The system of claim 1 wherein the AI engine is trained on a large dataset including dataset related to the at least one support ticket, wherein the training involves supervised learning such that the model learns to identify, extract and generate text based on labeled examples.

20. The system of claim 1 wherein data parsing is used to convert the at least one support ticket into a format suitable for processing by the NLP.

21. The system of claim 1 wherein the knowledge base article is stored in a knowledge base database.

22. The system of claim 1 wherein a data manager integrated into an AI-control system is configured to collect required data for the prompt generator to generate the plurality of prompts.
